(19) United States
(12) Patent Application Publication
(10) Pub. No.: US 2024/0282992 A1
(43) Pub. Date: Aug. 22, 2024

(54) METHOD FOR REGENERATING A FUEL CELL

(71) Applicants: COMMISSARIAT A L'ENERGIE ATOMIQUE ET AUX ENERGIES ALTERNATIVES, Paris (FR); Intelligent Energy Limited, Loughborough (GB)

(72) Inventors: Jessica Thery, Loughborough (GB); Vincent Faucheux, Loughborough (GB); Stephanie Lombard, Loughborough (GB)

(73) Assignee: Intelligent Energy Limited, Loughborough (GB)

(21) Appl. No.: 15/781,691

(22) PCT Filed: Dec. 8, 2016
(86) PCT No.: PCT/FR2016/053269

§ 371 Date: Apr. 6, 2020

(30) Foreign Application Priority Data
Dec. 10, 2015 (FR) 1562139

(51) Int. Cl. H01M 8/0662; H01M 8/04302; H01M 8/0432; H01M 8/04537; H01M 8/04746; H01M 8/10

(52) U.S. Cl. CPC H01M 8/0662; H01M 8/04302; H01M 8/04335; H01M 8/04552; H01M 8/04582; H01M 8/04753; H01M 2008/1095

(57) ABSTRACT

Method for regenerating a fuel cell comprising the following steps in succession: —providing a fuel cell comprising: an anodic chamber (1) equipped with a dihydrogen inlet (4), a dihydrogen outlet (5), and at least one anode (6); a cathodic chamber (2) equipped with a gas inlet (7), a gas outlet (8), and at least one cathode (9); and an injecting device (10) connected to the gas inlet (7) of the cathodic chamber (2) and to the dihydrogen outlet (5) of the anodic chamber (1) or to the dihydrogen inlet (4) of the anodic chamber (1), the injecting device (10) being configured to inject dihydrogen into the cathodic chamber (2) or to block the injection of dihydrogen; and —activating the injecting device (10) so as to inject dihydrogen into the cathodic chamber (2) in order to regenerate the cathode (9) during the operation of the fuel cell.

### TECHNICAL FIELD OF THE INVENTION

The invention relates to a method for regenerating a fuel cell, and, more particularly, to a method for regenerating the catalytic layers of the fuel cell.

### STATE OF THE ART

A proton exchange membrane fuel cell (PEMFC or “Proton Exchange Membrane Fuel Cell”) is an electric generator producing electricity, water and heat by electrochemical combustion of hydrogen and oxygen.

Fuel cells have two electrodes, an anode and a cathode, separated by an electrolytic membrane allowing the H⁺ protons to pass.

The electrodes are the seat of electrochemical reactions. They are formed of a layer of catalytic material, also called a catalyst layer, or a catalytic layer.

The anode is the seat of a reaction whose reactant is hydrogen according to:

$${H}_{2} 2 H Γ + 2 e “$$

At the cathode, the H⁺ protons formed at the anode react with oxygen according to:

$${/}_{2} {O}_{2} + 2 H Γ + 2 e “ -> {H}_{2} O$$

The anode and the cathode are respectively supplied with dihydrogen and with oxygen, by sources of reagent which can be, on the one hand pure hydrogen or hydrocarbons reformed for the source of hydrogen and, on the other hand, pure oxygen or air for the oxygen source.

The performance of the fuel cell is directly linked to the performance of the catalyst layers.

However, contaminants present in the gases, such as, for example, volatile organic compounds (VOCs) can adsorb on the surface of the catalyst layers. This contamination decreases the electrochemical performance of fuel cells.

Two approaches can be considered to avoid adsorption of organic contaminants on the catalytic layers.

A first approach consists in purifying the gases before they come into contact with the catalytic layers.

For example, in document US 2014/0212775, the fuel cell is supplied with dihydrogen by a hydrogen generator. This dihydrogen generator is provided with a device reducing the amount of CO contained in the gas, by virtue of a conversion reaction in which CO reacts with water vapor, in the presence of a catalyst of the CuZn type for example.

However, this embodiment is difficult to envisage for portable devices.

Another solution to purify the gas is to use filters. Such filters have already been used in fuel cells (US 2014/0103256), in particular for adsorbing sulfur-based impurities. The filter is a porous material based on copper oxide.

However, it is necessary to change the filters regularly.

Another solution is to clean the catalytic layers of the fuel cell to regenerate their performance.

Document US 2001/0044040 describes a process for regenerating a fuel cell with a proton exchange membrane operating at voltages between 0.75V and 0.85V. At such voltages, the surface of the platinum catalyst becomes covered with Pt—OH, reducing the number of active sites accessible.

Electric pulses, at voltages below 0.6V, are applied to the fuel cell cathode to reduce Pt—OH species, and reactivate the catalyst. For example, the battery operates at 0.77V for 300 s and then a 0.3V dip is applied for 3 s at each cycle.

It is also possible to oxidize the carbon monoxide adsorbed on the surface of an anode to regenerate the catalyst. For this, electrical pulses, of a potential higher than that of the anode potential, are applied (CA 2 284 589).

However, these methods require that pulses be applied frequently and regularly throughout the operation of the battery.

Document US Pat. the gas input from the cathode to the dihydrogen inlet from the anode, disconnect the fuel cell from the primary electrical circuit and connect it to a battery on an external circuit so as to produce electrons and H⁺ ions at cathode level. The battery is then reconnected to the primary circuit and to the arrival of oxidant. This process cannot be carried out for so-called breathable fuel cells, for which the oxygen necessary for the operation of the cathode comes directly from the ambient air.

### Subject of the Invention

The object of the invention is to propose a method for regenerating a fuel cell avoiding the drawbacks targeted by the prior art.

More particularly, the object of the invention is to propose a method for regenerating an efficient fuel cell, easy to implement and requiring no maintenance. The process must be feasible even when it is not possible to stop the flow of gas in the cathode, as for example in the case of fuel cells with a breathable proton exchange membrane.

We tend to this object by the appended claims.

### BRIEF DESCRIPTION OF THE DRAWINGS

Other advantages and characteristics will emerge more clearly from the description which follows of particular embodiments of the invention given by way of nonlimiting examples and represented in the appended drawings, in which:

FIGS. 1 to 4 schematically represent, in section, a fuel cell according to different embodiments,

FIG. 5 is a graph representing the current as a function of time for a fuel cell according to the prior art,

FIGS. 6 and 7 are graphs representing the current as a function of time for a fuel cell according to different embodiments of the invention,

FIG. 8 shows a polarization curve of a fuel cell before and after the regeneration process according to the invention.

### DESCRIPTION OF A PREFERRED EMBODIMENT OF THE INVENTION

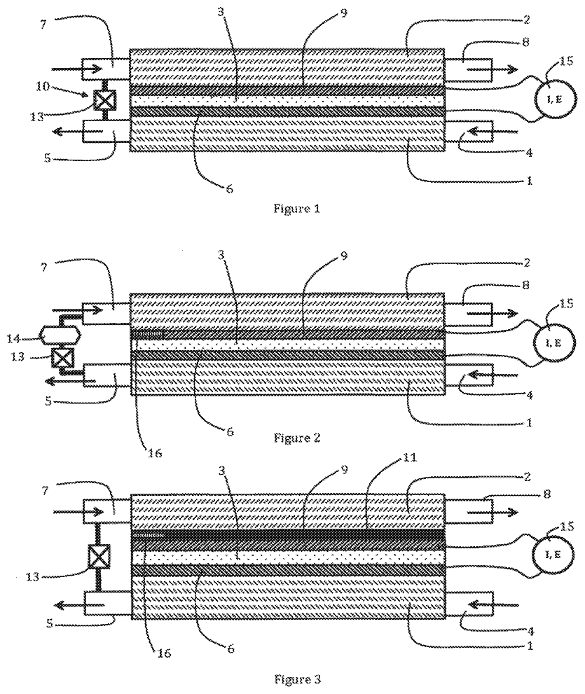

The regeneration process, also called reactivation or decontamination process, of a fuel cell comprises the following successive steps:
supply a fuel cell, as shown in FIGS. 1 to 4, comprising:
   an anode chamber 1 and a cathode chamber 2 separated by an electrolytic membrane 3,
      the anode chamber 1 being provided with an inlet 4 and dihydrogen an output dihydrogen 5,
      at least one anode 6 being arranged in the anode chamber 1,
      the cathode chamber 2 is provided with a gas inlet 7 and a gas outlet 8,
      at least one cathode 9 being disposed in the cathode chamber 2,
   an injection device 10 connected to the gas inlet 7 of the cathode chamber 2 and to the dihydrogen outlet 5 of the anode chamber 1 or to the dihydrogen inlet 4 of the anode chamber 1, the device injection 10 being configured to inject the hydrogen to the cathode chamber 2, or to block the injection of hydrogen,
activate the injection device 10 so as to inject dihydrogen into the cathode chamber 2 to regenerate the cathode.

Dihydrogen is injected into the cathode chamber 2 during the operation of the fuel cell.

The gas flow at the cathode (the oxidant flow) is maintained during the injection of dihydrogen.

The oxidizing gas has a dihydrogen content of less than 0.001% by volume.

The fuel cell is in normal operation during the regeneration step.

The fuel cell operating method includes:
a first stage of operation of the fuel cell,
a second stage of regeneration of the fuel cell which follows the first stage with addition of hydrogen in the gas supplied to the cathode, and—possibly a third stage of operation of the fuel cell where the flow of dihydrogen at the cathode is stopped.

In the previous three steps, the fuel cell powers an electrical charge that consumes electricity.

In these three stages, the current always flows in the same direction.

For the rest, the anode catalyst layer is assimilated to the anode 6 and the cathode catalyst layer to the cathode 9. The cathode catalyst layer 9 comprises, for example, platinum. It can be Pt/C or PtCo/C. The catalyst layer can be a porous layer.

According to a preferred embodiment (FIGS. 3 and 4), the cathode catalyst layer 9 is covered by a gas diffusion layer 11. According to an embodiment not shown, the anode 6 is also advantageously covered by a gas diffusion layer (or GDL for “gas diffusion layer”).

The diffusion layer in particular facilitates the transport of the reagents by distributing them homogeneously within the electrode.

When the dihydrogen is injected into the cathode chamber 2, a catalytic combustion of the dihydrogen on the catalytic sites of the cathode 9 occurs. This reaction makes it possible to clean the layer of cathode catalysts from the impurities present in said chamber and, more particularly, to regenerate the active catalytic sites on which impurities can be adsorbed.

Advantageously, the method makes it possible both to reactivate the layer of cathode catalysts and to clean the layer of anode catalysts of impurities, such as volatile organic compounds and carbon monoxide. carbon. The anode 6, heated by the catalytic reaction at the cathode 9, is thus purified.

Advantageously, the regeneration process is carried out during the operation of the fuel cell, that is to say that the dihydrogen and the oxidizing gas (air or dioxygen) arrive simultaneously in the cathode chamber 2.

Advantageously, the method also makes it possible to remove the excess water that can accumulate at the cathode 9 during the operation of the fuel cell.

This method of cleaning the electrodes improves the electrochemical performance of the fuel cell.

It can be implemented during the operation of the battery and does not require any particular maintenance.

As shown in FIGS. 1 to 4, the anode chamber is provided with a gas inlet 4, intended to be connected to a source of dihydrogen, such as a dihydrogen tank, and with a gas outlet 5.

The injection device 10 comprises a tube connected to the gas outlet 5 of the anode chamber 1 and to the gas inlet 7 of the cathode chamber 2. The dihydrogen, not consumed in the anode chamber, is advantageously recycled for clean, reactivate the electrodes.

The embodiment where the injection device 10 is connected both to the gas inlet 4 of the anode chamber 1 and to the gas inlet 7 of the cathode chamber is not shown.

The injection device 10 preferably comprises at least one valve 13 for regulating the arrival of the hydrogen in the cathode chamber 2. The valve 13 authorizes the injection of hydrogen or prevents the injection of hydrogen, depending on whether it is in open or closed position. Advantageously, the flow of dihydrogen can be adjusted with the valve 13.

The valve 13 can also be used to purge the cathode chamber 2 with a view to stopping and storing the fuel cell.

Advantageously, the pressure in the anode chamber 1 is higher than that of the cathode chamber 2, so as to obtain a gas flow from the anode chamber 1 to the cathode chamber 2.

According to a particular embodiment, shown in FIG. 2, the device also includes a fan 14, in order to obtain better homogenization of the gas mixture in the cathode chamber 2.

Preferably, the step of injecting the dihydrogen into the cathode chamber 2 is carried out according to the following steps:
measure the current or voltage supplied by the fuel cell,
compare the current or voltage measured with a reference value,
when the measured value is less than the reference value, activate the injection device 10 so as to inject dihydrogen into the cathode chamber 2.

Current and voltage are measured by an electrical measuring device 15, such as an ammeter or a voltmeter. The electrical measuring device 15 makes it possible to measure the performance of the electrochemical system.

The measuring device 15 is positioned at the electrodes of the fuel cell. The measuring device 15 is connected, ie electrically connected to the anode 6 and to the cathode 9 of the fuel cell.

When a drop in voltage (or current) is observed, the injection device 10 is activated and dihydrogen coming from the anode chamber 1 is injected into the cathode chamber 2.

An analysis and/or control system (not shown) can be used to control information relating to the electrical behavior of the fuel cell. This system can continuously monitor performance fuel cell electrics or occasionally, for example, at regular intervals.

If the fuel cell is operating in galvanostatic mode, the voltage is measured.

If the fuel cell is operating in potentiostatic mode, the current is measured.

If the voltage, or the current, reaches a value lower than a reference value, ie to an expected value, dihydrogen is injected into the cathode chamber 2.

By expected value is meant the voltage or current value which the fuel cell should normally deliver. For example, if a fuel cell must deliver a current of 0.9 A for a given efficiency (for example 0.6V/cell), the expected reference value is 0.9 A.

The detection of a current lower than the reference value leads to the injection of dihydrogen into the cathode chamber 2, via for example, the opening of the valve 13 between the anode chamber 1 and the cathode chamber 2.

Advantageously, the injection is carried out during the operation of the fuel cell. The fuel cell does not need to be shut down.

The dihydrogen mixes with the oxygen or with the air coming from the entry of oxygen 7 of the fuel cell.

The volume percentage of dihydrogen injected into the cathode chamber 2 is less than or equal to 4% relative to the total volume injected corresponding to the volume of dihydrogen and the volume of gas coming from the cathode gas inlet 7. The fuel cell can continue to function during the injection of dihydrogen.

For example, if the gas flow into the cathode chamber 2 is 100 cm air flow³/min (sccm or for “standard cubic centimeter per minute”), and if the flow of hydrogen has a same flow of 100 cm³/min, the valve 13 is open for 4 s then closed for 96 s.

The volume percentage of dihydrogen is greater than 0.05%, and, advantageously, greater than 0.5%.

Preferably, the arrival of gas 7 from the cathode chamber 2 is an arrival of oxygen. The gas inlet 7 is connected to a source of oxygen. The source of oxygen can be a reservoir of oxygen.

Preferably, the fuel cell is a so-called “breathing” or “breathing” cell, that is to say that the oxygen entering the cathode chamber 2 comes directly from the ambient air. The oxygen does not need to be stored or injected into the cathode chamber 2. The source of oxygen is the ambient air.

The cathode chamber 2 has an at least partially open structure, allowing the entry of air into said chamber.

In a breathable structure, the fuel cell operates at atmospheric pressure and at ambient temperature.

By atmospheric pressure is meant a pressure of the order of 1 bar. By ambient temperature is meant a temperature of the order of 20-25° C.

The anode chamber can be at a pressure higher than 1 bar.

The gas outlet 8 from the cathode chamber 2 makes it possible to evacuate the oxygen or the oxygen/dihydrogen mixture.

Preferably, the fuel cell is a fuel cell with a proton exchange membrane.

According to a particular embodiment, and as shown in FIGS. 2 to 4, a thermosensor 16, also called a thermal sensor, is placed in the cathode chamber 2.

The thermosensor 16 can be positioned at the cathode 9 (FIG. 2) or even at the cathode gas diffusion layer 11 (FIGS. 3 and 4).

The thermosensor 16 can be connected to a control circuit, configured to measure the temperature and control the injection of dihydrogen.

The temperature of the cathode chamber 2 is measured during the injection of dihydrogen. The temperature of the cathode, and therefore the temperature in the cathode chamber 2, can increase due to the catalytic combustion of dihydrogen, which is an exothermic reaction.

The injection of dihydrogen is stopped if the temperature exceeds a reference temperature. The reference temperature is between 80° C. and 200° C. and preferably less than 150° C., thus avoiding degradation of the membrane.

The local temperature measurement at the cathode is close to the temperature seen by the anode, since the anode and the cathode are only separated by an electrolyte membrane with a thickness of 10μιη to 50μιη. The reference temperature at the anode is advantageously also between 80° C. and 200° C. and preferably it is less than 150° C.

An anode temperature measurement can also be added.

Such temperatures lead to the elimination of organic impurities, such as volatile organic compounds (VOCs) or carbon monoxide CO, and to the purification of the layer of anodic catalysts.

It is considered that there is contamination by impurities when this results in a drop in performance. It can be a few ppb of impurities (part per billion, or “part per billion” in English).

Advantageously, during the injection of dihydrogen, part of the excess water can be evaporated, thanks to the increase in temperature, and/or evacuated from the cathode chamber 2, thanks to the gas flow. Advantageously, the additional resistances linked to mass transport are reduced, leading to an improvement in the performance of the cell, in particular, for temperatures above 100° C.

Advantageously, the injection of dihydrogen can participate in the hydration of the electrolyte thanks to the creation of a water molecule at the cathode, in particular, for temperatures below 100° C.

The excess water can come from the functioning of the cell, and more particularly, from the cathodic reaction: Vi O₂+2H⁺+2e″->H₂O

During the operation of the fuel cell, the electrode 9 can become saturated with water, resulting in a reduction in the efficiency of the fuel cell insofar as the condensed water hinders the passage of hydrogen to the catalytic sites of the cathode 9.

The injection of dihydrogen makes it possible to considerably reduce or even eliminate the excess water at the active sites of the electrode 9 and/or of the gas diffusion layer 11.

According to a preferred embodiment, and as shown in FIG. 4, the cathode chamber 2 can be provided with a hydrophobic layer 17 called water management. The water management layer 17 and the gas diffusion layer 11 can also be combined into a single layer.

By hydrophobic is meant that when a drop of water is deposited on the layer, the contact angle is strictly greater than 90°.

The water management layer 17 is, for example, made of fluoropolymer.

This water management layer 17 ensures the balance between the retention of water, necessary for good hydration of the membrane, and the evacuation of water. This layer facilitates the evacuation of excess water from the cathode chamber 2.

It is advantageously porous in order to be able not only to authorize the supply of oxygen but also to efficiently evacuate the water produced at the cathode 9.

Advantageously, the positioning of the water management layer 17 and of the catalytic layer 9, capable of carrying out catalytic combustion and exothermic hydrogen, will be chosen to locate the overheating zones near the water accumulation zones in order to more easily evaporate the water present in the cathode chamber 2.

An injection of dihydrogen can advantageously be carried out for a fuel cell under cold start conditions.

Cold start means temperatures close to 0° C. or below 0° C., for example for temperatures down to −20° C.

During cold operation, the water can freeze in the cathode chamber 2. This happens, for example, when the fuel cell supplied is previously stored at temperatures lower than or equal to 0° C.

The injection of dihydrogen and its catalytic combustion with dioxygen warms the cathode, and the frozen water, once liquefied, is discharged. The injection of dihydrogen leads to a heating of said cell and allows it to be used under cold start conditions.

The fuel cell may start cold. The fuel cell can advantageously be used for fixed applications or even mobile applications, such as in a car for example.

During cold start, the fuel cell is connected to the electrical circuit.

In FIGS. 1 to 4, the fuel cell comprises a single elementary cell: a membrane 3 separating the anode 6 from the cathode 9.

According to a particular embodiment not shown, the fuel cell comprises at least two elementary cells. Each elementary cell comprising a pair of electrodes (anode/cathode), the anode and the cathode being separated by the electrolytic membrane.

An electrolytic membrane can be specific to each elementary cell. According to an alternative, the same electrolytic membrane is common to at least two elementary cells. The anodes are all arranged in the anode chamber so that hydrogen can diffuse on the catalytic sites of the anodes. Likewise, the cathodes are all arranged in the cathode chamber.

The production process will now be described by means of the examples below given by way of illustration and not limitation.

During the storage phase, the cathode catalyst layer 9 of the fuel cell can be contaminated with organic compounds.

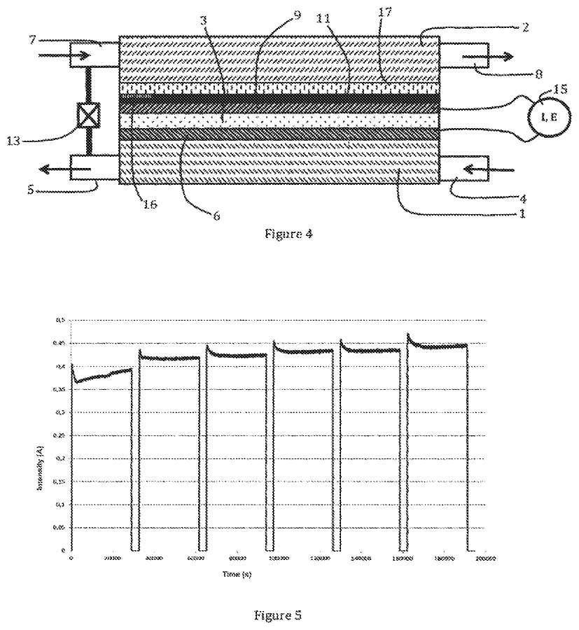

As shown in FIG. 5, without reactivation of the catalytic layer by dihydrogen, several hours of operation are necessary for the fuel cell to regain its nominal value, here it is the nominal current.

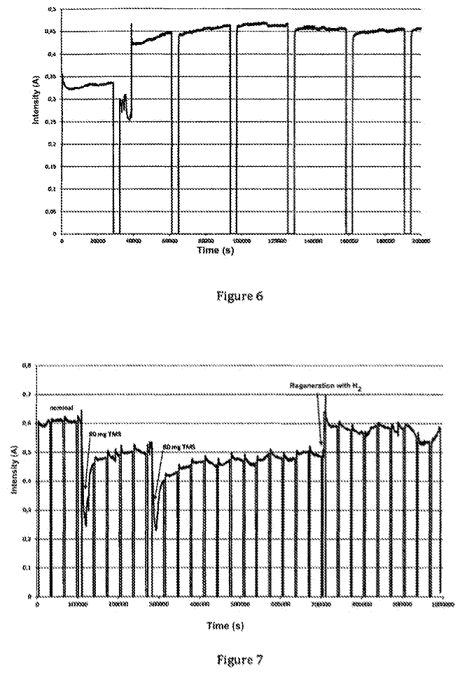

FIG. 6 represents the intensity as a function of time of a fuel cell reactivated by dihydrogen.

At the start of the measurements, directly after the storage phase, without reactivation of the cathode chamber 2, the intensity is of the order of 0.32 A. An injection of dihydrogen is carried out at the start of the second cycle to clean and reactivate the cathode chamber 2. On three occasions, 90 cm³/min of dihydrogen are injected for 5 s into the cathode chamber 2.

After the reactivation phase, the intensity supplied by the fuel cell is increased by at least 30%.

The production method allows cathodes to be cleaned quickly and efficiently.

According to another example, the method is used to clean an anode 6 contaminated with volatile organic compounds (VOCs).

FIG. 7 represents the intensity as a function of time of a fuel cell, the anode 6 of which has been contaminated with VOCs and then cleaned.

The first three cycles correspond to the nominal current delivered by the battery at an efficiency of 50%. During the fourth cycle and the fifth cycle of operation of the cell, 80 mg of trimethylsilanol (TMS) are injected into the anode, leading to a reduction in the nominal current supplied by the fuel cell.

In the 22^{nd} cycle, the anode is cleaned by means of an injection of dihydrogen at the cathode (90 cm³/min for 10 s) which makes it possible to heat the anode 6 and to clean it of said compounds. The catalytic reaction at the cathode 9 leads to a heating of the anode 6, which makes it possible to quickly and efficiently clean the anodic catalytic layer 6.

The current supplied by the fuel cell increases, confirming the effectiveness of cleaning.

Advantageously, the anode 6 is cleaned and the cathode 9 is reactivated at the same time.

In a last example, the method is used to improve the humidification of the fuel cell.

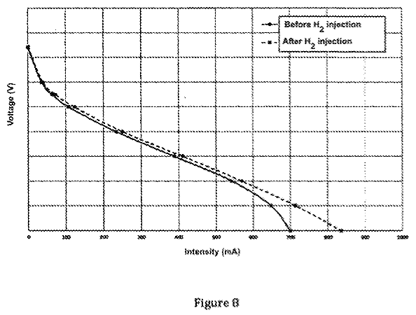

FIG. 8 represents a polarization curve of a fuel cell with a proton exchange membrane under so-called drying conditions (solid curve), that is to say when the membrane is dried out at high currents. From 550 mA, the current decreases significantly due to the drying of the membrane.

An injection of dihydrogen is carried out, leading to an increase in temperature up to 110° C. and the creation of water molecules at the cathode. After this injection step, a new polarization curve is produced (dotted curve—FIG. 8). The current is improved in the mass transfer zone.

1. Method for regenerating a fuel cell comprising the following successive steps:
provide a fuel cell comprising:
an anode chamber (1) and a cathode chamber (2) separated by an electrolytic membrane (3), the anode chamber (1) being provided with a dihydrogen inlet (4) and a dihydrogen outlet (5),
at least one anode (6) being arranged in the anode chamber (1), the cathode chamber (2) being provided with a gas inlet (7) and a gas outlet (8), at least one cathode (9) being disposed in the cathode chamber (2), an injection device (10) connected to the gas inlet (7) of the cathode chamber (2) and to the dihydrogen outlet (5) of the anode chamber (1) or to the dihydrogen inlet (4) from the anode chamber (1), the injection device (10) being configured to inject the dihydrogen towards the cathode chamber (2), or to block the injection of dihydrogen,
activate the injection device (10) so as to inject dihydrogen into the cathode chamber (2) to regenerate the cathode (9) during the operation of the fuel cell.

2. Method according to claim 1, the method characterized in that the step of injecting the dihydrogen into the cathode chamber (2) is carried out according to the following steps:
measure the current or voltage supplied by the fuel cell, compare the current or voltage measured with a reference value,
when the measured value is lower than the reference value, activate the injection device (10) so as to inject dihydrogen into the cathode chamber (2).

3. Method according to claim 1, the method characterized in that the volume percentage of dihydrogen injected into the cathode chamber (2) is less than or equal to 4%.

4. Method according to claim 1, the method characterized in that a thermosensor (16) is arranged in the cathode chamber (2) and in that the temperature of the cathode chamber (2) is measured during the injection of dihydrogen, the injection of dihydrogen being stopped if the temperature exceeds a reference temperature.

5. Method according to claim 1, the method characterized in that the gas inlet (7) of the cathode chamber (2) is an inlet of oxygen.

6. Method according to claim 1, the method characterized in that the oxygen entering the cathode chamber (2) comes from the ambient air.

7. Method according to claim 1, the method characterized in that the fuel cell is a proton exchange membrane fuel cell.

8. Method according to claim 1, the method characterized in that the anode (6) is contaminated with organic compounds, such as volatile organic compounds or carbon monoxide, and in that the injection of dihydrogen in the cathode chamber (2) makes it possible to heat the anode (6) and to clean it of said compounds.

9. Method according to claim 8, the method further characterized in that the fuel cell supplied is, beforehand, stored at temperatures lower than or equal to 0° C., the injection of dihydrogen leading to a heating of said battery and allowing it to be used in cold start conditions.

10. A fuel cell comprising
an anode chamber (1) and a cathode chamber (2) separated by an electrolytic membrane (3), the anode chamber (1) being provided with a gas inlet, intended to be connected to a source of hydrogen (4), and of a gas outlet (5), at least one anode (6) being arranged in the anode chamber (1), the cathode chamber (2) being provided with a gas inlet (7) and a gas outlet;
at least one cathode (9) being arranged in the cathode chamber (2), characterized in that an injection device (10) is connected to the gas inlet (7) of the cathode chamber (2) and to the dihydrogen outlet (5) from the anode chamber (1) or the dihydrogen inlet (4) from the anode chamber (1), the injection device (10) being configured to inject di hydrogen to the cathode chamber (2) during the operation of the fuel cell, or to block the injection of dihydrogen.

11. The fuel cell of claim 10, characterized in that an electrical measuring device (15) is connected to the anode (6) and to the cathode (9) of the fuel cell.

12. The fuel cell according to claim 11, characterized in that a thermosensor (16) is arranged in the cathode chamber (2).

13. The fuel cell according to claim 12, characterized in that the gas inlet (7) of the cathode chamber (2) is connected to a source of oxygen.

14. Fuel cell according to claim 13, characterized in that the fuel cell is a fuel cell with a proton exchange membrane.

15. (canceled)
